(19) United States
(12) Patent Application Publication
(10) Pub. No.: US 2015/0077354 A1
(43) Pub. Date: Mar. 19, 2015

(54) Screen Control System of Handheld Devices and Method Thereof

(71) Applicants: INVENTEC APPLIANCES (JIANGNING) CORPORATION, NANJING (CN); INVENTEC APPLIANCES CORP., NEW TAIPEI CITY (TW)

(72) Inventor: Xian-Nun JIANG, Nanjing (CN)

(73) Assignees: INVENTEC APPLIANCES (JIANGNING) CORPORATION, NANJING (CN); INVENTEC APPLIANCES CORP., NEW TAIPEI CITY (TW)

(21) Appl. No.: 14/282,970

(22) Filed: May 20, 2014

(30) Foreign Application Priority Data
Sep. 13, 2013 (CN) 201310419978.7

(51) Int. Cl. G06F 3/041

(52) U.S. Cl. CPC G06F 3/041
USPC 345/173

(57) ABSTRACT

A system for controlling a screen on a handheld device includes a gravity sensor, a proximity sensor, and a processing unit. The gravity sensor is configured for determining a direction in which a screen on a handheld device is facing. The proximity sensor is configured for determining whether the screen is in proximity to an object or not. And the processing unit is coupled to the gravity sensor, the proximity sensor, and the screen, and configured to conduct turning off the screen when the screen is facing downwards and in proximity to the object. Related methods of controlling a screen on a handheld device are also provided.

### CROSS-REFERENCE TO RELATED APPLICATION

This application claims the benefit of China Patent Application No. 201310419978.7, filed on Sep. 13, 2013, which is hereby incorporated by reference for all purposes as if fully set forth herein.

### BACKGROUND

1. Field of the Invention

The present invention relates to a system for controlling a screen on a handheld device and method thereof, and more particularly, to a system for controlling a screen on a handheld device and a method thereof, which controls the screen of a handheld device automatically by a gravity sensor, a proximity sensor and a processing unit.

2. Related Art

With handheld devices developing nowadays like PDAs, smart phones and tablet computers, it may be a challenge for handheld devices manufacturers to reduce power consumption and increase battery life with battery size and charging capacity limitations. Moreover, displaying is one of the most power consuming functions in handheld devices. Most of the time, users are used to put their handheld device into a pocket or a suitcase directly or turn over their handheld device on the desk without shutting off the screen of the handheld device. Although most of handheld devices provide a sleep mode, it still consumes additional power before the screen is shut off.

### SUMMARY

In order to overcome the deficiencies of prior art, an object of the present invention is to provide a system for controlling a screen on a handheld device and a method thereof, in order to turn off the screen on the handheld device when the screen is facing downwards and in proximity to an object.

Therefore, the present invention provides a system for controlling a screen on a handheld device, including a gravity sensor, a proximity sensor, and a processing unit. The gravity sensor is configured for determining a direction in which a screen on a handheld device is facing. The proximity sensor is configured for determining whether the screen is in proximity to an object or not. The processing unit is coupled to the gravity sensor, the proximity sensor, and the screen, and configured to conduct turning off the screen when the screen is facing downwards and in proximity to an object.

Preferably, the system may further include a timing module coupled to the processing unit and configured to measure a screen-on duration of the screen, and the processing unit is configured to conduct turning off the screen when the screen-on duration expires.

The present invention also provides a method of controlling a screen on a handheld device, including: using a gravity sensor to determine a direction in which a screen on a handheld device is facing; using a proximity sensor to determine whether the screen is in proximity to an object or not; and turning off the screen when the screen is facing downwards and in proximity to the object.

Preferably, the method may further include measuring a screen-on duration of the screen; and turning off the screen when the screen-on duration expires.

The present invention further provides a method of controlling a screen, including: activating a gravity sensor and a proximity sensor upon a screen on a handheld device being turned on by a controlling unit; using the gravity sensor to determine a direction in which the screen is facing; using the proximity sensor to determine whether the screen is in proximity to an object or not; and using a processing unit, coupled to the gravity sensor, the proximity sensor, and the screen, to turn off the screen when the screen is facing downwards and in proximity to the object; and turning off the gravity sensor and the proximity sensor upon the screen being turned off by the controlling unit.

### BRIEF DESCRIPTION OF THE DRAWINGS

FIG. 1 is a block diagram of a system for controlling a screen on a handheld device according to the present invention.

FIG. 2 is a flow chart of turning off a screen on a handheld device of the system according to the present invention.

FIG. 3 is a flow chart of turning on a screen on a handheld device of the system according to the present invention.

FIG. 4 is a loop flow of a system for controlling a screen on a handheld device according to the present invention.

### DETAILED DESCRIPTION

To understand the above feature and advantages of the present invention, reference will now be made in detail to the preferred embodiment of the present disclosure, examples of which are illustrated in the accompanying drawings. The accompanying drawings are simplified drawings schematically drawn for the purpose of describing basic structure of the present invention.

The following descriptions referred to relative drawings will illustrate embodiments of the system for controlling a screen on a handheld device and method thereof, and the same parts and components will represent the same symbols so that they can be easily understood.

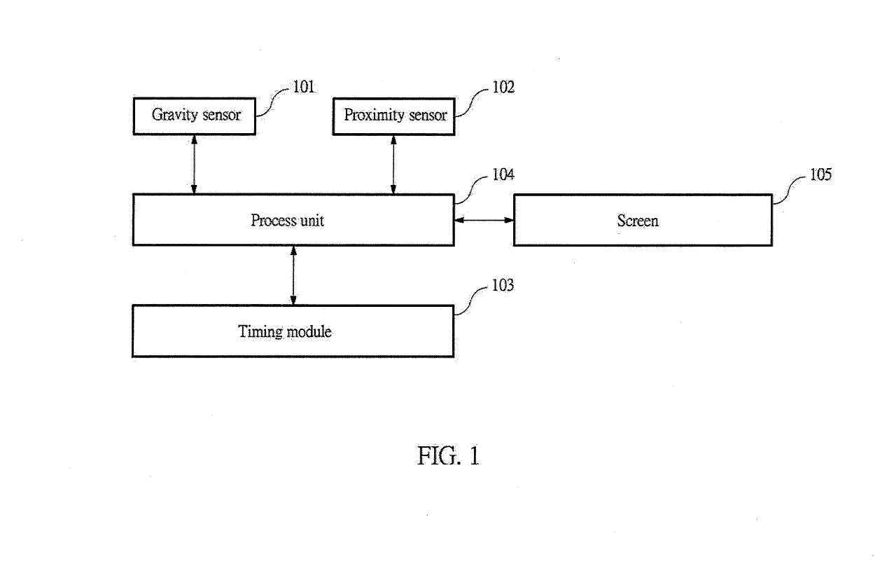

Referring to FIG. 1, it is a block diagram of a system for controlling a screen on a handheld device according to the present invention. In FIG. 1, the system for controlling a screen on a handheld device comprises a gravity sensor 101, a proximity sensor 102, a processing unit 104 and a screen 105.

The gravity sensor 101 is configured for determining a direction in which the screen 105 is facing. The proximity sensor 102 is configured for determining whether the screen 105 is in proximity to an object or not. In addition, the processing unit 104 is coupled to the gravity sensor 101, the proximity sensor 102, and the screen 105, and the processing unit 104 is configured to conduct turning off the screen 105 when the screen 105 is facing downwards and in proximity to an object.

Any particular limit of the distance between the screen 105 and an object can be chosen (e.g. through a design choice of/by a person of skill in the art to improve controlling the screen 105 or the convenience of using the handheld device) so that when the distance is within the limit the screen 105 will be determined to be in proximity to the object.

In addition, the system for controlling a screen on a handheld device further comprises a timing module 103 coupled to the processing unit 104 and configured to measure a screen-on duration of the screen 105, and the processing unit 104 is configured to conduct turning off the screen 105 when the screen-on duration expires, wherein the screen-on duration is a predetermined time and the screen-on duration is set up as long as the handheld device is not in use.

In addition, the processing unit 104 activates the gravity sensor 101 and the proximity sensor 102 before the screen-on duration expires.

In addition, the processing unit 104 is configured to conduct turning off the gravity sensor 101 and the proximity sensor 102 upon the screen-on duration expiring.

In addition, the processing unit 104 keeps the screen 105 on when the screen 105 is either not facing downwards or not in proximity to an object, before the screen-on duration expires.

In addition, the handheld device may further comprise a physical button used to control the power of the screen as a controlling unit, therefore the gravity sensor 101, the proximity sensor 102 and the screen-on duration may be activated or terminated according to the power of the screen. For example, when the user uses the physical button to turn on the screen, and the gravity sensor 101, the proximity sensor 102 and the screen-on duration may be activated, otherwise, when the user uses the physical button to turn off the screen, and the gravity sensor 101, the proximity sensor 102 and the screen-on duration may be turned off or terminated.

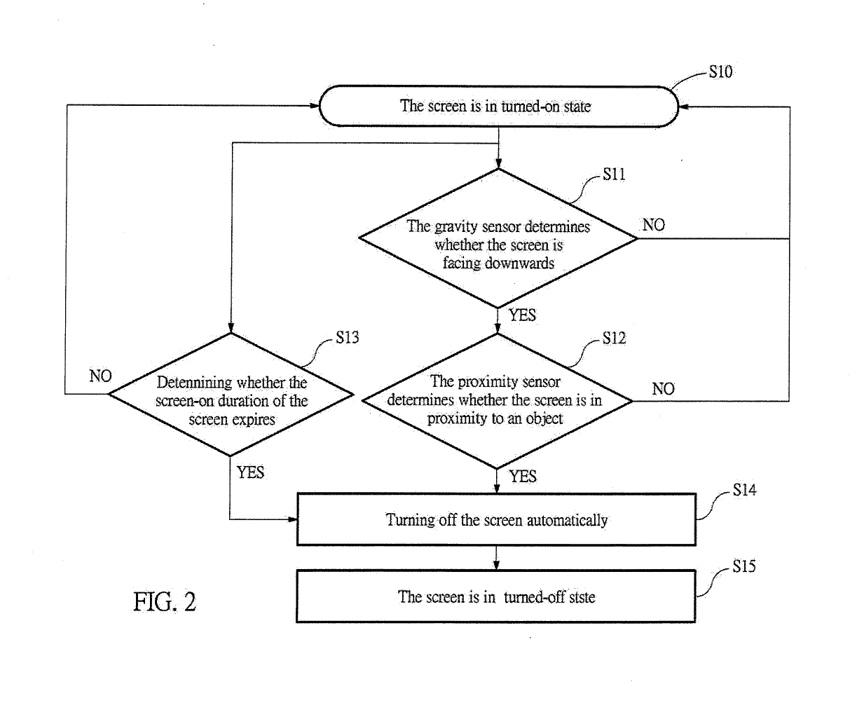

Referring to FIG. 2, it is a flow chart of turning off a screen on a handheld device of a system according to the present invention. In Step S10, the screen is in turned-on state, and then Steps S11 and S13 will be performed.

In Step S11, the gravity sensor determines whether the screen is facing downwards or not. If yes, Step S12 will be performed. If no, back to Step S10.

In Step S12, the proximity sensor determines whether the screen is in proximity to an object or not. If yes, Step S14 will be performed. If no, back to Step S10.

In Step S13, it will determine whether the screen-on duration expires or not. If yes, Step S14 will be performed. If no, back to Step S10.

In Step S14, the screen will be turned off automatically, and Step S15 will be performed.

In Step S15, the screen is in turned-off state.

For example, when the screen on the handheld device of the present invention is facing downwards and in proximity to an object like a tabletop, a bed, a briefcase or a pocket etc, the processing unit determines that the handheld device is not in use, and turns off the screen on the handheld device. In addition, when the user neither turns over the screen nor makes the screen approaching to an object, the processing unit will still turn off the screen on the handheld device when the screen-on duration of the screen expires.

In other words, as long as the screen-on duration of the screen expires or the screen is facing downwards and in proximity to an object, the processing unit will turn off the screen automatically.

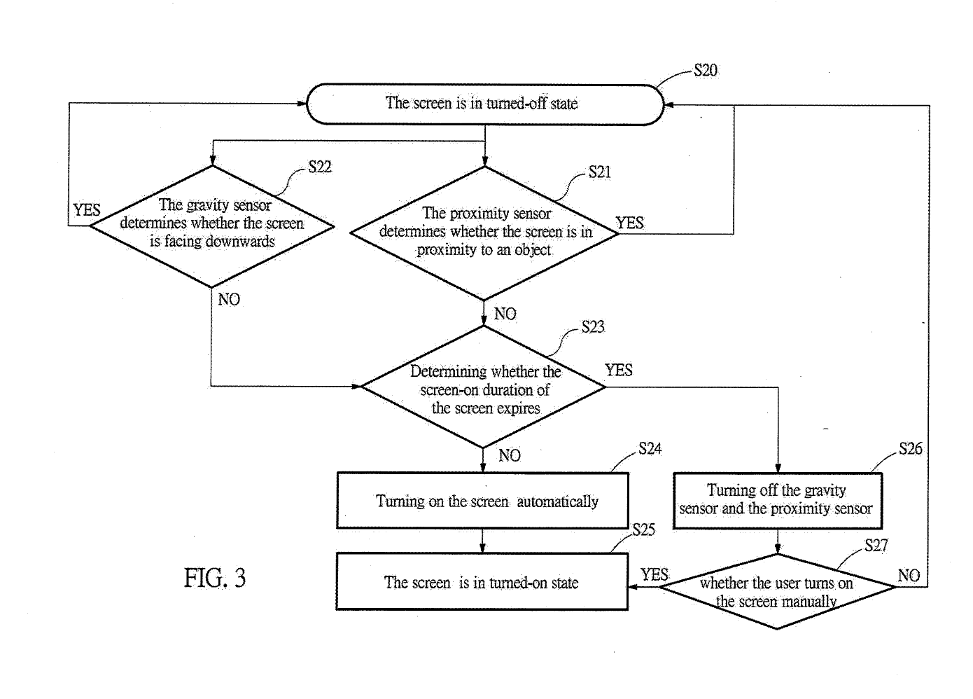

Referring to FIG. 3, it is a flow chart of turning on a screen on a handheld device of a system according to the present invention. In Step S20, the screen is in turned-off state, and then Step S21 and S22 will be performed.

In Step S21, the proximity sensor determines whether the screen is in proximity to an object or not. If yes, back to Step S20. If no, Step S23 will be performed.

In Step S22, the gravity sensor determines whether the screen is facing downwards or not. If yes, back to Step S20. If no, Step S23 will be performed.

In Step S23, it will determine whether the screen-on duration expires or not. If no, Step S24 will be performed. If yes, Step S26 will be performed.

In Step S24, the screen is turned on automatically, and then Step S25 will be performed.

In Step S25, the screen on the handheld device is in turned-on state.

In Step S26, the gravity sensor and the proximity sensor are in turned-off state, and then Step S27 will be performed.

In Step S27, it will determine whether the user turns on the screen manually or not. If yes, Step S25 will be performed. If no, back to Step S20.

For example, before the screen-on duration expires and the screen is picked up from facing downwards and in proximity to an object such as a tabletop, a bed, a briefcase or a pocket etc, the screen will be turned on automatically from turned-off state. However, after the screen-on duration expires and the screen is picked up from facing downwards and in proximity to an object, the screen will keep in turned-off state.

In other words, the processing unit turns on the screen on the handheld device automatically only when the screen-on duration of the screen has not expired and the screen is neither facing downwards nor in proximity to an object.

In addition, the user may turn on the screen on the handheld device manually.

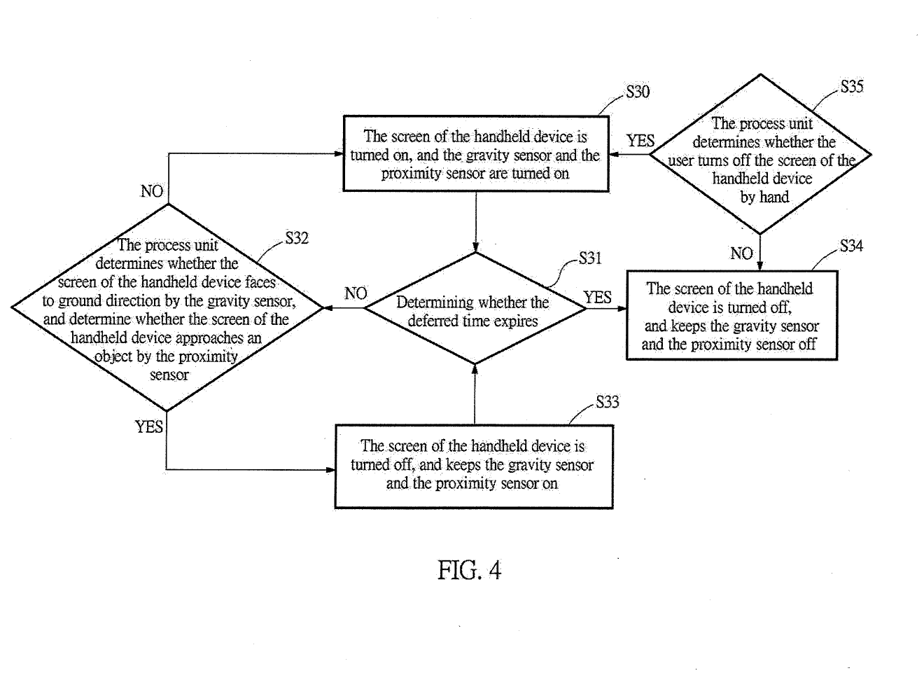

Referring to FIG. 4, it is a loop flow of a system for controlling a screen on a handheld device according to the present invention. In Step S30, the screen on the handheld device has been turned on, similarly, the gravity sensor and the proximity sensor are in turned-on state, and then Step S31 will be performed.

In Step S31, it will determine whether the screen-on duration of the screen expires or not. If the screen-on duration has expired, Step S34 will be performed. If the screen-on duration has not expired yet, Step S32 will be performed.

In Step S32, the gravity sensor determines whether the screen is facing downwards, and the proximity sensor determines whether the screen is in proximity to an object. If the screen is facing downwards and in proximity to an object, Step S33 will be performed. If the screen is neither facing downwards nor in proximity to an object, then back to Step S30.

In Step S33, since the screen is facing downwards and in proximity an object, the processing unit turns off the screen. The screen is turned off, but the processing unit keeps the gravity sensor and the proximity sensor in turned-on state, and back to Step S31.

In Step S34, since the screen-on duration has already expired, the processing unit turns off the screen. The screen is turned off and Step S35 will be performed.

In Step S35, the processing unit determines whether the user turns off the screen manually. If the user turns on the screen manually, then back to Step S30. If the user does not turn on the screen manually, then back to Step S34.

For example, when the user turns on the screen, the processing unit performs Step S30˜S32 or S31˜S33 continually until the screen-on duration expires, and it will determine whether turns on or off the screen according to every step.

In general, practicing the present invention may have one or more of the following advantages:

(1) When the screen-on duration expires, the processing unit turns off the screen to save the power consumption of the handheld device.
(2) Although the screen-on duration has not expired yet, the processing unit turns off the screen when the screen is facing downwards and in proximity to an object.
(3) Until the screen-on duration expires, the processing unit keeps the screen on when the screen is either not facing downwards or not in proximity to the object, before the screen-on duration expires.

In other words, before the screen-on duration expires, the system for controlling a screen on a handheld device will turn on or off the screen according to different status thereof to save power consumption of the handheld device and increase the convenience when using the handheld device.

The previous description of the preferred embodiment is provided to further describe the present invention, not intended to limit the present invention. Any modification apparent to those skilled in the art according to the disclosure within the scope will be construed as being included in the present invention.

What is claimed is:

1. A system for controlling a screen on a handheld device, comprising:
a gravity sensor configured for determining a direction in which a screen on a handheld device is facing;
a proximity sensor configured for determining whether the screen is in proximity to an object or not; and
a processing unit coupled to the gravity sensor, the proximity sensor, and the screen, and configured to conduct turning off the screen when the screen is facing downwards and in proximity to the object.

2. The system according to claim 1, further comprising a timing module coupled to the processing unit and configured to measure a screen-on duration of the screen, and the processing unit is configured to conduct turning off the screen when the screen-on duration expires.

3. The system according to claim 2, wherein the processing unit is configured to conduct activating the gravity sensor and the proximity sensor before the screen-on duration expires.

4. The system according to claim 2, wherein the processing unit is configured to conduct turning off the gravity sensor and the proximity sensor upon the screen-on duration expiring.

5. The system according to claim 2, the processing unit is configured to conduct keeping the screen on when the screen is either not facing downwards or not in proximity to the object, before the screen-on duration expires.

6. A method of controlling a screen on a handheld device, comprising:
using a gravity sensor to determine a direction in which a screen on a handheld device is facing;
using a proximity sensor to determine whether the screen is in proximity to an object or not; and
turning off the screen when the screen is facing downwards and in proximity to the object.

7. The method according to claim 6, further comprising:
measuring a screen-on duration of the screen; and
turning off the screen when the screen-on duration expires.

8. The method according to claim 7, further comprising:
activating the gravity sensor and the proximity sensor before the screen-on duration expires, for using the gravity sensor and the proximity sensor.

9. The method according to claim 7, further comprising:
turning off the gravity sensor and the proximity sensor upon the screen-on duration expiring.

10. The method according to claim 7, further comprising:
keeping the screen on when the screen is either not facing downwards or not in proximity to the object, before the screen-on duration expires.

11. A method of controlling a screen, comprising:
activating a gravity sensor and a proximity sensor upon a screen on a handheld device being turned on by a controlling unit;
using the gravity sensor to determine a direction in which the screen is facing;
using the proximity sensor to determine whether the screen is in proximity to an object or not; and
using a processing unit, coupled to the gravity sensor, the proximity sensor, and the screen, to turn off the screen when the screen is facing downwards and in proximity to the object; and
turning off the gravity sensor and the proximity sensor upon the screen being turned off by the controlling unit.

12. The method according to claim 11, before a screen-on duration of the screen expires, further comprising:
the processing unit conducting keeping the screen on when the handheld device is either not facing downwards or not in proximity to the object.

13. The method according to claim 11, further comprising:
the processing unit conducting turning off the screen when a screen-on duration of the screen expires.

14. The method according to claim 11, further comprising:
the processing unit conducting turning off the gravity sensor and the proximity sensor upon a screen-on duration of the screen expiring.

15. The method according to claim 11, wherein:
the controlling unit comprises a physical button on the handheld device.
